(19) United States
(12) Patent Application Publication
(10) Pub. No.: US 2017/0021709 A1
(43) Pub. Date: Jan. 26, 2017

(54) METHOD AND DEVICE FOR CHANNEL SEALING

(71) Applicant: Zephyros, Inc., Romeo, MI (US)

(72) Inventor: Jeffery A. Bradley, Imlay City, MI (US)

(21) Appl. No.: 15/212,786

(22) Filed: Jul. 18, 2016

Related U.S. Application Data
(60) Provisional application No. 62/196,053, filed on Jul. 23, 2015.

(51) Int. Cl. B60J 10/30; B60J 10/50

(52) U.S. Cl. CPC B60J 10/30; B60J 10/50

(57) ABSTRACT

A method and device for sealing an area on a transportation vehicle where a channel joins a secondary member which may be a door.

### TECHNICAL FIELD

The present teachings relate generally to a method and device for sealing an area on a vehicle where a channel joins a secondary member which may be a door.

### BACKGROUND

The transportation industry continues to require improved methods for sealing cavity and joint areas of transportation vehicles. Ineffective sealing within vehicle structures can lead to a number of problems including undesired noise, vibration, corrosion, joint failure and others.

There is thus a need for improved means of sealing vehicle structures including interface (e.g., joint areas).

### SUMMARY OF THE INVENTION

In a first aspect the present teachings contemplate a sealing assembly for use in a transportation vehicle, comprising a channel, a secondary member for connecting to the channel, and a connector including a hinge portion and a receiving portion connecting the channel and secondary member, wherein the receiving portion includes first and second extensions for contacting the channel. The channel may receive a glass panel. The hinge may flex from a first position to a second position upon receipt of the channel within the receiving portion. The hinge first position and second position may be separated by at least 10°, at least 20°, at least 45°, or even at least 60°. Force created by the channel contacting the first extension may cause flexing of the hinge. The connector may include an activatable material. The secondary member may be a door panel. The connector may include a heat activatable material.

In a second aspect of the present teachings, there is contemplated a method of sealing an area within a transportation vehicle comprising providing a channel adapt to receive a substrate, locating a connector onto a secondary member, the connector including a hinge portion and a receiving portion, and locating the channel into contact with the receiving portion of the connector, whereby the hinge portion is flexed upon contact between the channel and the connector.

The channel may receive a glass substrate. The receiving portion may include a first and second extension. The method may include moving the channel into contact with the first extension thereby causing flexing of the hinge portion.

The teachings herein contemplate a device and method for the sealing of vehicle interface with a hinged connector. The sealing assembly disclosed herein may allow for effective sealing between a channel and a secondary member which may be a door.

### DESCRIPTION OF THE DRAWINGS

FIG. 1 shows a perspective view of an illustrative example of the sealing assembly of the present teachings.

FIG. 2 shows a perspective view of an illustrative example of the sealing assembly of the present teachings.

### DETAILED DESCRIPTION

The explanations and illustrations presented herein are intended to acquaint others skilled in the art with the invention, its principles, and its practical application. Accordingly, the specific embodiments of the present disclosure as set forth are not intended as being exhaustive or limiting. The scope of the invention should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

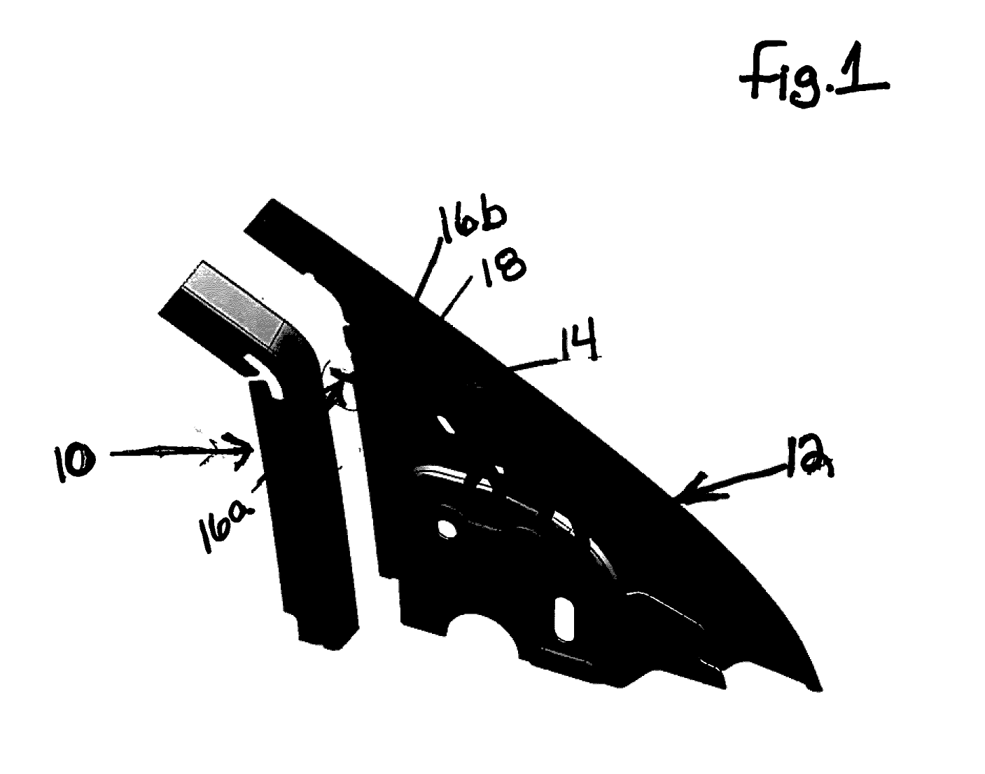

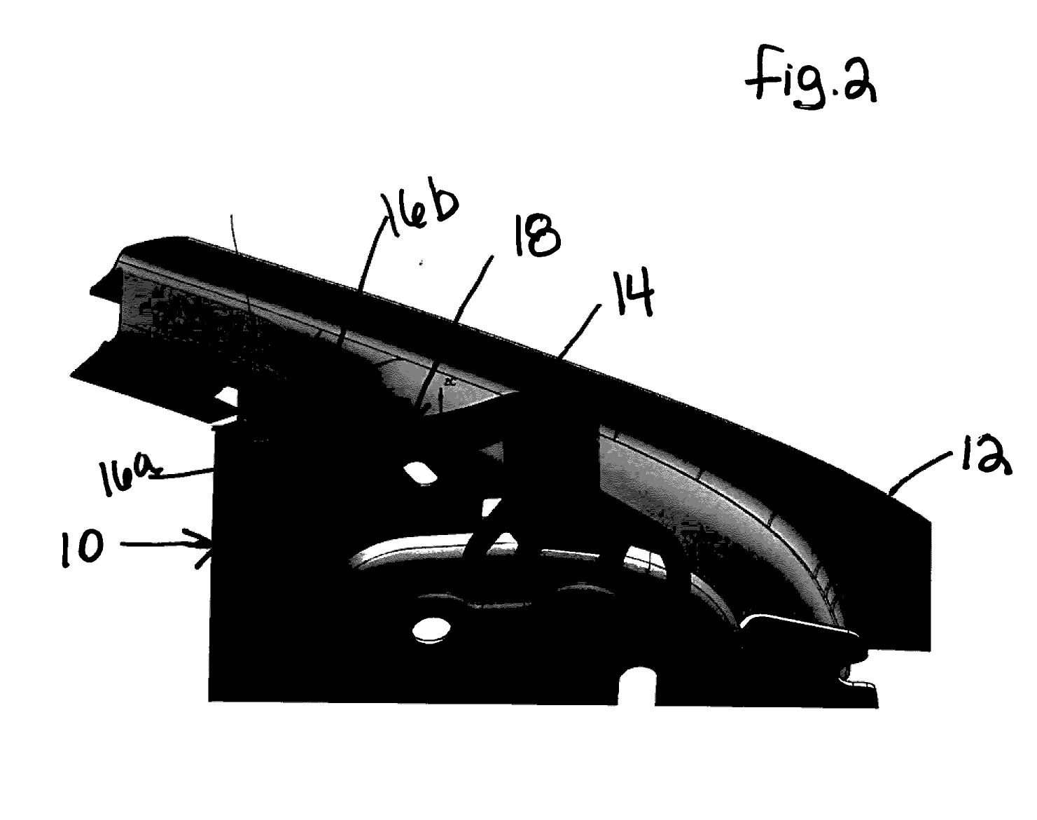

As shown in FIG. 1 and FIG. 2, the sealing assembly includes a channel 10, a secondary member 12, and a connector 14. The connector 14 includes a first extension 16b and a second extension 16a. The connector 14 also includes a hinge portion 18.

The channel 10 is received by the first extension 16a and second extension 16b as shown in FIG. 2. Upon contact between the first extension 16b and the channel 10, the hinge portion 18 flexes, allowing the first extension to come into direct contact with the secondary member 12.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1: A sealing assembly for use in a transportation vehicle, comprising:
i. a channel;
ii. a secondary member for connecting to the channel; and
iii. a connector including a hinge portion and a receiving portion connecting the channel and secondary member, wherein the receiving portion includes first and second extensions for contacting the channel.

2: The sealing assembly of claim 1, wherein the channel receives a glass panel.

3: The sealing assembly of claim 1, wherein the hinge flexes from a first position to a second position upon receipt of the channel within the receiving portion.

4: The sealing assembly of claim 3, wherein the hinge first position and second position are separated by at least 10°, at least 20°, at least 45°, or even at least 60°.

5: The sealing assembly of claim 1, wherein force created by the channel contacting the first extension causes flexing of the hinge.

6: The sealing assembly of claim 1, wherein the connector includes an activatable material.

7: The sealing assembly of claim 1, wherein the secondary member is a door panel.

8: The sealing assembly of claim 1, where the connector includes a heat activatable material.

9: A method of sealing an area within a transportation vehicle comprising:
i. providing a channel adapt to receive a substrate;
ii. locating a connector onto a secondary member, the connector including a hinge portion and a receiving portion; and
iii. locating the channel into contact with the receiving portion of the connector, whereby the hinge portion is flexed upon contact between the channel and the connector.

10: The method of claim 9, wherein the channel receives a glass substrate.

11: The method of claim 9, wherein the receiving portion includes a first and second extension.

12: The method of claim 11, including moving the channel into contact with the first extension thereby causing flexing of the hinge portion.
